(19) United States
(12) Patent Application Publication
(10) Pub. No.: US 2016/0291361 A1
(43) Pub. Date: Oct. 6, 2016

(54) LIQUID CRYSTAL DISPLAY MODULE

(71) Applicants: INTERFACE OPTOELECTRONICS (SHENZHEN) CO., LTD., GUANGDONG (CN); GENERAL INTERFACE SOLUTION LIMITED, MIAOLI COUNTY (TW)

(72) Inventors: MANG FU, GUANGDONG (CN); CHING-HUANG LIN, GUANGDONG (CN)

(21) Appl. No.: 14/748,402

(22) Filed: Jun. 24, 2015

(30) Foreign Application Priority Data
Apr. 3, 2015 (CN) 201510157524.6

(51) Int. Cl. G02F 1/1339

(52) U.S. Cl. CPC G02F 1/1339

(57) ABSTRACT

The present invention discloses a liquid crystal display module (LCM) to overcome the problem caused by a gap, which is formed in a masking tape to make the cell module unlikely to peel off from the backlight module. The present invention seals the gap with a resin to prevent dirt, moisture, or foreign matters from entering the liquid crystal display module lest the liquid crystal display module be polluted. Therefore, the present invention can maintain the quality of LCM, decrease the probability of discarding LCM, promote the yield of LCM, and reduce the cost of LCM fabrication.

This application claims priority for China patent application no. 201510157524.6 filed on Apr. 3, 2015, the content of which is incorporated by reference in its entirely.

### BACKGROUND OF THE INVENTION

1. Field of the Invention

The present invention relates to a liquid crystal display module, particularly to a liquid crystal display module, the gap of whose masking tape is sealed.

2. Description of the Related Art

Owing to advance of science and technology, portable electronic devices have been extensively used in daily life, such as notebook computers, tablet computers, and smart phones. With the dependency increasing, the function of portable electronic devices is growing stronger and stronger. All portable electronic devices have display screens for presenting video information.

The most common display screen is the liquid crystal display screen, which comprises a liquid crystal display module (LCD module or LCM). An LCD module includes a cell module and a backlight module (BLU). The cell module and the backlight module are joined together by a masking tape. The space enclosed by the cell module, the backlight module and the masking tape is an airtight space. With the action of assembling together the plate structures of the cell module and the backlight module, air is trapped inside the airtight space with its pressure increased. Thus, the cell module is likely to peel off from the backlight module.

Normally, a small opening is formed in the masking tape to release the pressure so as to solve the problem of peel off. However, the opening would interconnect the original airtight space and the external environment. Thus, dirt, moisture and foreign matters are likely to enter the space between the cell module and the backlight module, seriously degrading the quality of LCM or even causing LCM to be rejected. Therefore, the existence of the small opening not only decreases the yield but also increases the fabrication cost.

### SUMMARY OF THE INVENTION

The primary objective of the present invention is to provide a liquid crystal display module, wherein the space between the cell module and the backlight module is completely isolated from the environment, whereby dirt, moisture and foreign matters are unlikely to enter the space, wherefore the quality of the liquid crystal display module is promoted and the problem of the conventional technology is solved.

To achieve the abovementioned objective, the present invention proposes a liquid crystal display module, which comprises a backlight module and a cell module stuck to the backlight module with a masking tape and is characterized in that the masking tape has at least one gap and that the gap is sealed with a resin.

In one embodiment, the resin is a thermosetting resin.

In one embodiment, the resin is a light-cured resin.

In one embodiment, the resin is a dual-component resin.

In one embodiment, the masking tape has a plurality of gaps.

In one embodiment, the gaps divide the masking tape into a plurality of segments.

In one embodiment, the gaps are regularly distributed in the masking tape.

In one embodiment, the resin is used to seal the gap after the cell module has been stuck to the backlight module.

In one embodiment, the masking tape is a circular tape with a gap making the cell module tightly stuck to the backlight module.

In one embodiment, the resin seals the gap of the masking tape to make the space between the cell module and the backlight module an airtight space.

Below, embodiments are described in detail to make easily understood the objectives, technical contents, characteristics and accomplishments of the present invention.

### BRIEF DESCRIPTION OF THE DRAWINGS

FIG. 1A is an exploded view schematically showing a liquid crystal display module according to one embodiment of the present invention;

FIG. 1B is a sectional view schematically showing a liquid crystal display module according to one embodiment of the present invention;

FIG. 2 is a sectional view schematically showing a resin disposed in a liquid crystal display module according to one embodiment of the present invention;

FIG. 3A and FIG. 3B are diagrams respectively schematically showing different configurations of gaps of masking tapes of liquid crystal display modules according to different embodiments of the present invention; and

FIG. 4A and FIG. 4B are diagrams respectively schematically showing different shapes of liquid crystal display modules according to different embodiments of the present invention.

### DETAILED DESCRIPTION OF THE INVENTION

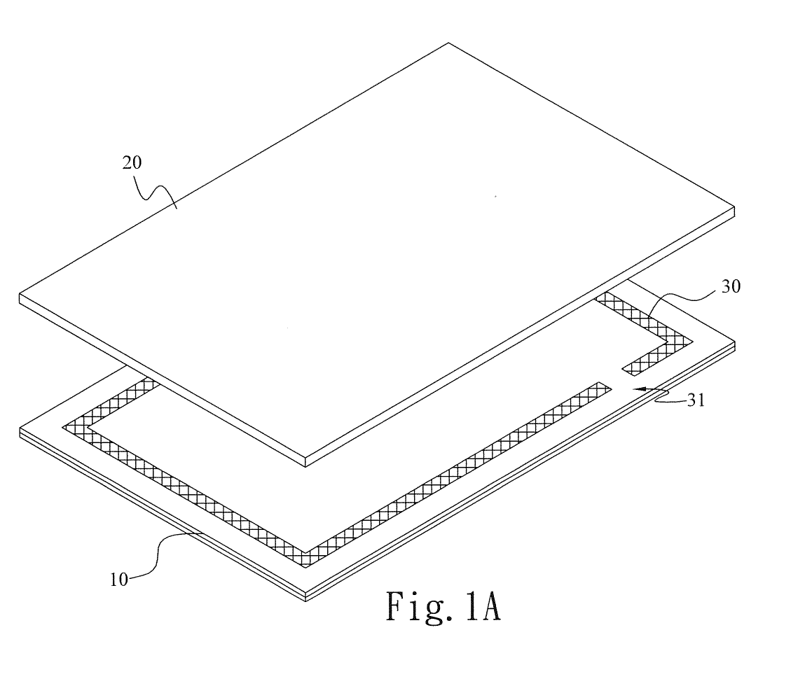

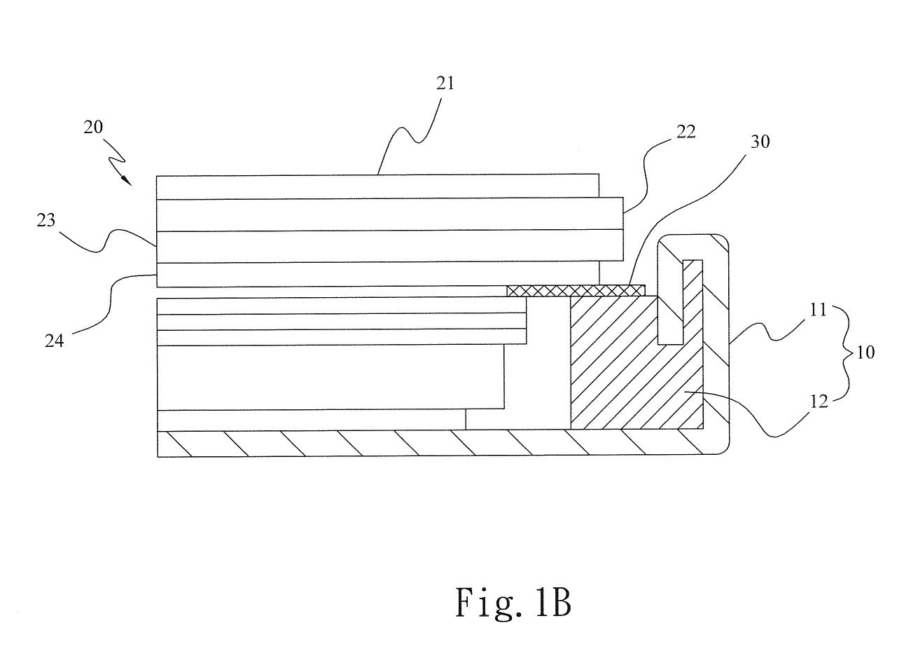

Refer to FIG. 1A and FIG. 1B respectively an exploded view and a sectional view of a liquid crystal display module according to one embodiment of the present invention.

The liquid crystal display module (LCD module or LCM) of the present invention comprises a cell module 20 and a backlight module (BLU) 10, wherein the cell module 20 is stuck to the backlight module 10 with a masking tape 30. The masking tape 30 is disposed along and stuck to the perimeter of the backlight module 10. Then, the cell module 20 is pressed to the backlight module 10 so as to join them together. The backlight module 10 is supported by a bezel 11 and a frame 12. The cell module 20 includes an upper polarizing plate 21, a color filter plate 22, a liquid crystal array 23 and a lower polarizing plate 24 in sequence. In FIG. 1B, it can be seen: the masking tape 30 is located between the lower polarizing plate 24 and the frame 12. In principle, the masking tape 30 should not exceed the border of the frame 12. It should be noted: FIG. 1A and FIG. 1B do not show a complete liquid crystal display device but only show a portion of components of LCM of the present invention.

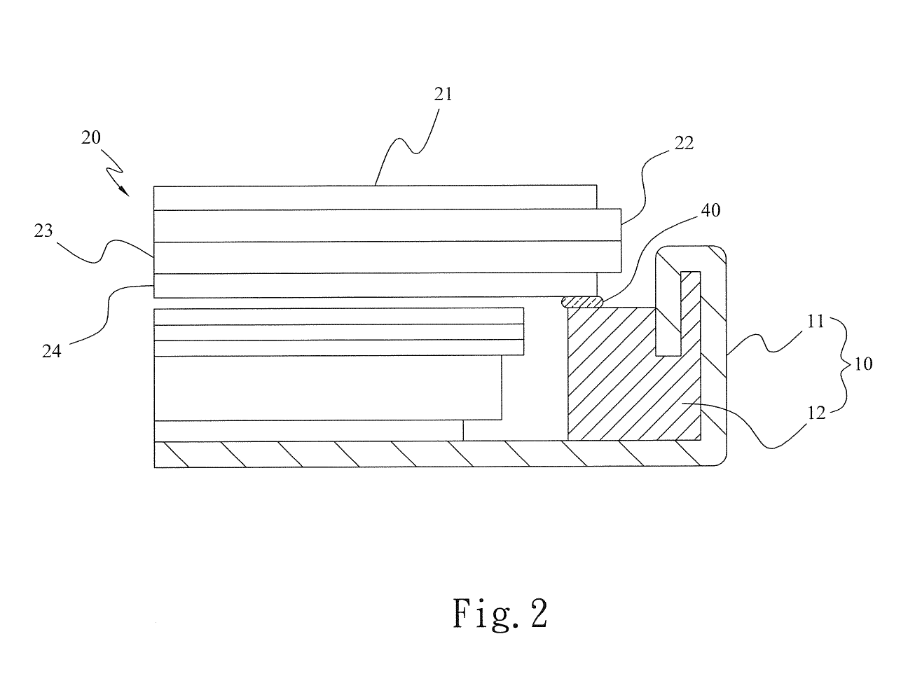

As mentioned above, the masking tape 30 has a gap 31. Therefore, the masking tape 30 is a circular tape with the gap 31. After the cell module 20 is pressed to the backlight module 10, the gap 31 can make the cell module 20 tightly stuck to the backlight module 10 and hard to peel off from the backlight module 10. Refer to FIG. 2. After the cell module 20 has been stuck to the backlight module 10, a resin 40 is used to seal the gap 31 and make the space between the cell module 20 and the backlight module 10 in an airtight state lest dirt, moisture or foreign matters enter the space through the gap 31. Therefore, the present invention can maintain the quality of LCM, decrease the probability that dirt, moisture or foreign matters cause LCM to be discarded, promote the yield of LCM, and reduce the cost of LCM fabrication.

The resin 40 may be but is not to be a thermosetting resin, a light-cured resin, or a dual-component resin (AB resin). The thermosetting resin is selected from a group consisting of epoxy resins, phenolic resins, urea-formaldehyde resins, melamine resins, silicone resins, furan resins, unsaturated polyester resins, acrylic resins, polyimides, polybenzimidazole, polyvinyl acetal modified phenolic resins, phenolic polyamide resins, novolac epoxy resins, and epoxy polyamide resins. The light-cured resin is also called the UV-cured resin and is selected from a group consisting of polymethacrylate resins and unsaturated polyester resins. The dual-component resin (AB resin) involves two types of resins, such as an epoxy resin and an amino resin, which are mixed to generate a crosslink reaction and thus cured. However, the present invention does not limit that the resin must be that mentioned above.

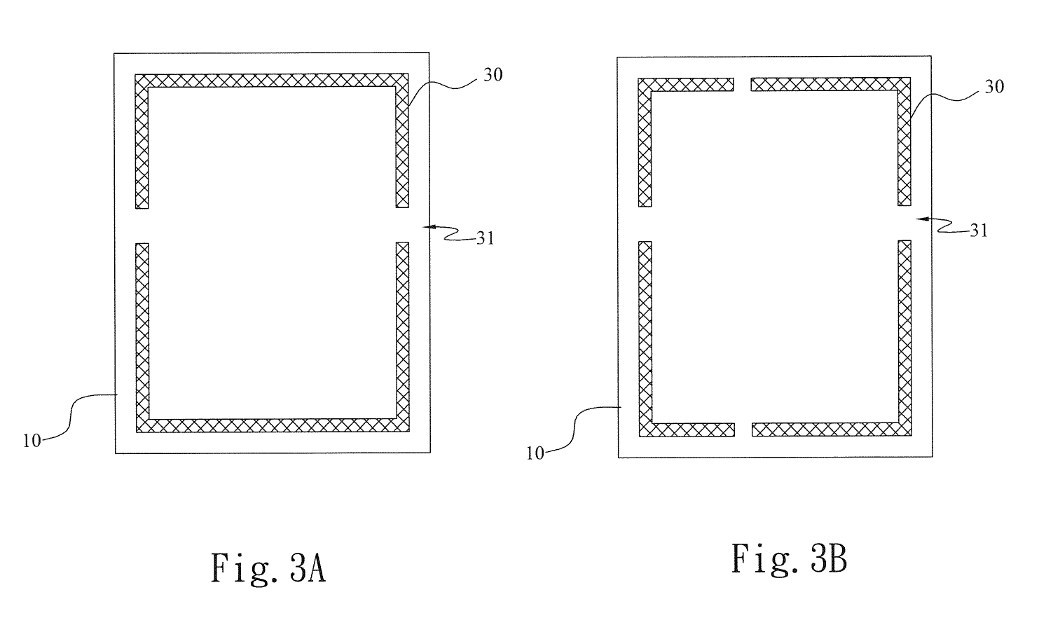

On the other hand, the positions and number of the gaps 31 of the masking tape 30 are not limited by FIG. 1. The masking tape 30 may have a plurality of gaps 31, such as two gaps 31 (as shown in FIG. 3A) or four gaps 31 (as shown in FIG. 3B). In the embodiments shown in FIG. 3A and FIG. 3B, the gaps 31 are distributed regularly to divide the masking tape 30 into a plurality of segments. The number and positions of the gaps 31 can be designed according to practical requirement of LCM. The embodiments described above are only to exemplify the present invention but not to limit the scope of the present invention.

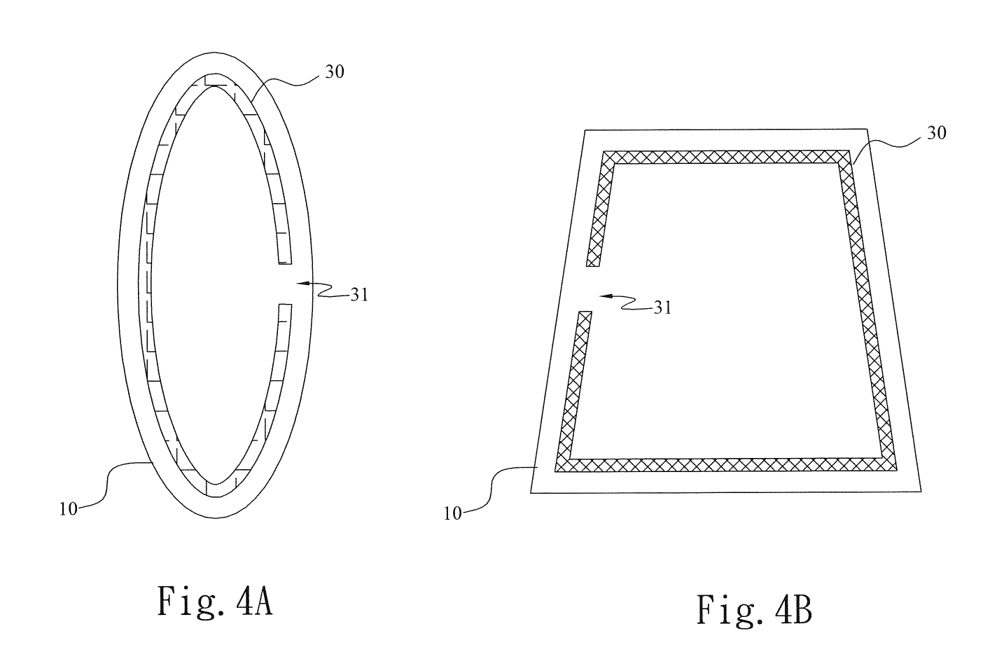

Besides, the present invention does not particularly limit that the shape of LCM must be like that shown in the abovementioned drawings. In some embodiments, LCM has another geometrical shape, such as that shown in FIG. 4A or FIG. 4B.

In conclusion, the present invention proposes a liquid crystal display module to overcome the conventional problem caused by a gap, which is formed in the masking tape to make the cell module tightly stuck to the backlight module. The present invention seals the gap with a resin after the cell module has been stuck to the backlight module, whereby the space between the cell module and the backlight module is airtightly sealed, and whereby dirt, moisture or foreign matters would not enter the space through the gap. Therefore, the present invention can maintain the quality of LCM, decrease the probability of discarding LCM, promote the yield of LCM, and reduce the cost of LCM fabrication.

The embodiments described above are only to exemplify the present invention but not to limit the scope of the present invention. Any equivalent modification or variation according to the spirit or characteristic of the present invention is to be also included within the scope of the present invention.

What is claimed is:

1. A liquid crystal display module comprising a backlight module and a cell module stuck to said backlight module with a masking tape, and characterized in
that said masking tape has at least one gap and that said gap is sealed with a resin.

2. The liquid crystal display module according to claim 1, wherein said resin is a thermosetting resin.

3. The liquid crystal display module according to claim 1, wherein said resin is a light-cured resin.

4. The liquid crystal display module according to claim 1, wherein said resin is a dual-component resin.

5. The liquid crystal display module according to claim 1, wherein said masking tape has a plurality of gaps.

6. The liquid crystal display module according to claim 5, wherein said gaps divide said masking tape into a plurality of segments.

7. The liquid crystal display module according to claim 5, wherein said gaps are regularly distributed in said masking tape.

8. The liquid crystal display module according to claim 1, wherein said resin is used to seal said gap after said cell module has been stuck to said backlight module.

9. The liquid crystal display module according to claim 1, wherein said masking tape is a circular tape with said gap making said cell module tightly stuck to said backlight module.

10. The liquid crystal display module according to claim 9, wherein said resin seals said gap to make a space between said cell module and said backlight module be an airtight space.
